(19) United States
(12) Patent Application Publication
(10) Pub. No.: US 2009/0228491 A1
(43) Pub. Date: Sep. 10, 2009

(54) METHOD, COMPUTER PROGRAM PRODUCT, AND APPARATUS FOR RULE-BASED RELEASE OF DISTRIBUTED ELECTRONIC CONTENT

(75) Inventor: Dale Malik, Atlanta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 12/043,521

(22) Filed: Mar. 6, 2008

(51) Int. Cl. G06F 17/30

(52) U.S. Cl. 707/10; 707/E17.032

(57) ABSTRACT

Rule-based release of distributed electronic content in accordance with at least one content release rule is provided. A first subcontent, a second subcontent, and a content release rule specifying a first condition for enabling access to the first subcontent and a second condition for enabling access to the second subcontent, are received. The received first subcontent, the received second subcontent, and the received content release rule are stored in a content storage device. Access to the stored first subcontent is not enabled, and access to the stored second subcontent is not enabled. Access to the stored first subcontent is enabled in accordance with the content release rule. Access to the stored second subcontent is enabled in accordance with the content release rule.

### BACKGROUND

The present invention relates generally to electronic content distribution and, more specifically, to rule-based release of distributed electronic content in accordance with at least one content release rule.

Existing techniques for distributing electronic content are subject to bandwidth limitations. For example, an Internet Protocol television (IPTV) connection to a user premises may have a maximum bandwidth of 24 megabytes per second. At the same time, a typical IPTV service may provide users with the choice of hundreds of program streams such as real time television broadcasts, on-demand video programs, and interactive events. Given the bandwidth limitations of the user premises connection, as well as the finite bandwidth capacities of practical IPTV distribution networks, it is not feasible to simultaneously transmit all available program streams to the user. Rather, one or more program streams are transmitted to the user in response to a user request.

The practice of transmitting IPTV program streams on request leads to distribution network congestion during peak periods of use, as well as inefficient use of the distribution network during off-peak hours. For example, the weekday hours of 8:00 PM to 11:00 PM Eastern Standard Time (EST) represent prime time viewing during which relatively large numbers of users are expected to watch IPTV program streams. During these hours, network capacity may be challenged. By contrast, viewership is relatively low from 2:00 AM to 6:00 AM EST, with portions of the network remaining underutilized.

### SUMMARY

Exemplary embodiments relate to a method for rule-based release of distributed electronic content in accordance with at least one content release rule. A first subcontent, a second subcontent, and a content release rule specifying a first condition for enabling access to the first subcontent and a second condition for enabling access to the second subcontent, are received. The received first subcontent, received second subcontent, and received content release rule are stored in a content storage device. Access to the stored first subcontent is not enabled, and access to the stored second subcontent is not enabled. Access to the stored first subcontent is enabled in accordance with the content release rule. Access to the stored second subcontent is enabled in accordance with the content release rule.

Another set of exemplary embodiments include a computer program product for rule-based release of distributed electronic content in accordance with at least one content release rule. The computer program product includes a storage medium readable by a processing circuit and storing instructions for execution by the processing circuit for facilitating a method. The method includes receiving a first subcontent, a second subcontent, and a content release rule specifying a first condition for enabling access to the first subcontent and a second condition for enabling access to the second subcontent. The received first subcontent, received second subcontent, and received content release rule are stored in a content storage device. Access to the stored first subcontent is not enabled, and access to the stored second subcontent is not enabled. Access to the stored first subcontent is enabled in accordance with the content release L rule. Access to the stored second subcontent is enabled in accordance with the content release rule.

Another set of exemplary embodiments includes an apparatus for rule-based release of distributed electronic content in accordance with at least one content release rule. The apparatus receives a first subcontent, a second subcontent, and a content release rule, the content release rule specifying a first condition for enabling access to the first subcontent and a second condition for enabling access to the second subcontent. The apparatus stores the received first subcontent, the received second subcontent, and the received content release rule in a content storage device, wherein access to the stored first subcontent is not enabled and access to the stored second subcontent is not enabled. The apparatus enables access to the stored first subcontent in accordance with the content release rule. The apparatus enables access to the stored second subcontent in accordance with the content release rule.

Other methods, computer program products, and systems according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a simplified block diagram of an exemplary system for rule-based release of distributed electronic content in accordance with at least one content release rule.

FIG. 2 is a flowchart of an exemplary procedure for rule-based release of distributed electronic content in accordance with at least one content release rule.

FIG. 3 is a simplified block diagram of an exemplary computer program product for rule-based release of distributed electronic content in accordance with at least one content release rule.

The detailed description explains the exemplary embodiments, together with advantages and features, by way of example with reference to the drawings.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

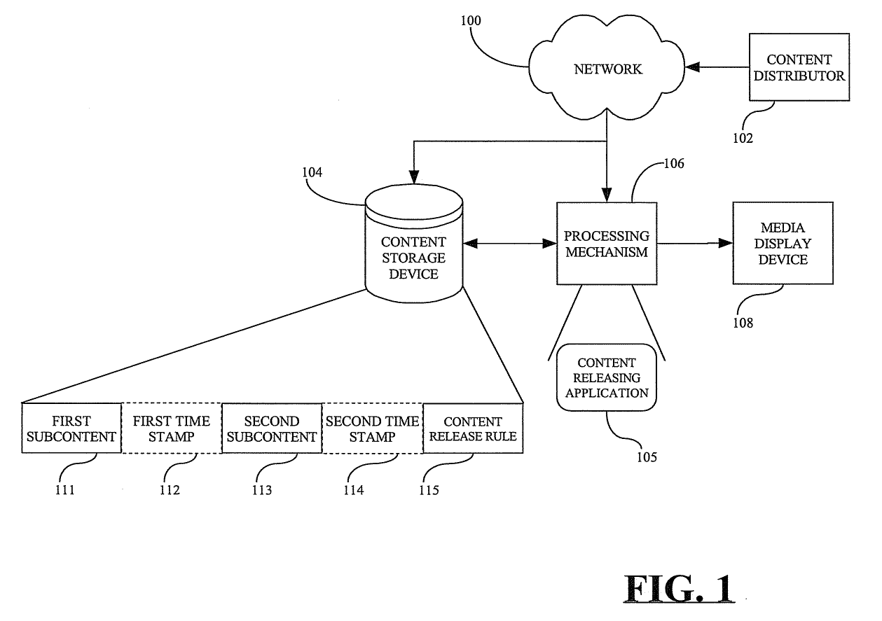

FIG. 1 is a simplified block diagram of a first exemplary system for rule-based release of distributed electronic content in accordance with at least one content release rule. A processing mechanism 106 is operatively coupled to a content distributor 102 over a network 100. According to exemplary embodiments, the processing mechanism 106 is equipped with a content releasing application 105. The processing mechanism 106 may receive a first subcontent 111, a second subcontent 113, and a content release rule 115 from the content distributor 102 over the network 100. Optionally, the processing mechanism 106 receives a first time stamp 112 associated with the first subcontent 111 and a second time stamp 114 associated with the second subcontent 113. According to exemplary embodiments, if the optional first time stamp 112 and the optional second time stamp 114 are employed, then the content release rule 115 may, but need not, be employed. On the other hand, if one or more of the optional first time stamp 112 and the optional second time stamp 114 are not employed, then the content release rule 115 is employed. Illustratively, the first subcontent 111 and the second subcontent 113 may, but need not, each represent Internet Protocol television (IPTV) programs.

According to exemplary embodiments, the content release rule 115 specifies a first condition for enabling access to the first subcontent 111 and a second condition for enabling access to the second subcontent 113. The optional first time stamp 112 may specify a first time after which access to the first subcontent 111 is enabled. Prior to the first time specified by the first time stamp 112, access to the first subcontent 111 is not enabled, such that the first subcontent 111 cannot be accessed by a user of the processing mechanism 106, such as for display on a media display device 108. Similarly, the optional second time stamp 114 may specify a second time after which access to the second subcontent 113 is enabled. Prior to this second time specified by the second time stamp 114, access to the second subcontent 113 is not enabled, such that the second subcontent 113 cannot be accessed by a user of the processing mechanism 106, such as for display on the media display device 108. Illustratively, the content release rule may include at least one time stamp such as the first time stamp 112 and the second time stamp 114.

According to exemplary embodiments, the first subcontent 111 represents a first item of electronic content distributed by the content distributor 102, and the second subcontent 113 represents a second item of electronic content distributed by the content distributor 102. A content distributor may choose to send content that is directly associated with an electronic program guide (EPG) and containing a time stamp associated with the scheduled broadcast shown in the EPG. If the content is not associated with an EPG, and is being distributed on some scheduled basis, then the content is put in a categorized folder under that content's heading (e.g., Murder Mysteries). When more than one item of content is sent that is of the same category, these items can be sent from the same distributor as sub-content elements to direct the processing mechanism 106 that these sub-content elements include related content. Alternatively or additionally, each item of content and each subcontent element may be labeled individually. For example, if the content distributor delivers an “I Love Lucy” 3-hour special, including a total of 4 shows, then the special may be sent as 4 sub-content elements. Subcontent elements may not apply to shows in the EPG

In some cases, the first subcontent 111 may represent a first episode of a weekly, daily or recurring television program, whereas the second subcontent 113 may represent a second episode of the weekly, daily, or recurring television program. To illustrate further, the first subcontent 111 may represent an episode of the Lost™ TV series airing on February 1^{st}, whereas the second subcontent 113 may represent an episode of the Lost™ TV series airing on February 8^{th}. Alternatively or additionally, the first subcontent 111 may represent a first program trailer downloaded from the content distributor 102 to the processing mechanism 106 over the network 100 in response to a user viewing a specified program. Similarly, the second subcontent 113 may represent a second program trailer downloaded from the content distributor 102 to the processing mechanism 106 over the network 100 in response to the user viewing a specified program.

A content storage device 104 may be operatively coupled to the processing mechanism 106. The storage device could be located remotely from the processing mechanism 106 such that the processing mechanism 106 communicates with the storage device 104 over a network. Illustratively, the storage device 104 may be part of a home networked device or a set top box. According to exemplary embodiments, the processing mechanism 106 stores received first subcontent 111, received second subcontent 113, and a received content release rule 115 in the content storage device 104. Access to the stored first subcontent 111 may not be enabled, such that the first subcontent 111 cannot be accessed by a user of the processing mechanism 106, such as for display on the media display device 108. Access to the stored second subcontent 113 may not be enabled, such that the second subcontent 113 cannot be accessed by a user of the processing mechanism 106, such as for display on the media display device 108. The media display device 108 is operatively coupled to the processing mechanism 106.

According to exemplary embodiments, the processing mechanism 106 enables access to the stored first subcontent 111, such as for display on the media display device 108, in accordance with the content release rule 115 and the content releasing application 105, and/or in accordance with the optional first time stamp 112 and the content releasing application 105. Conceptually, if the first time stamp 112 is employed, then the first time stamp 112 effectively functions as a time-based content release rule, similar to the content release rule 115. Similarly, the processing mechanism 106 enables access to the stored second subcontent 113, such as for display on the media display device 108, in accordance with the content release rule 115 and the content releasing application 105, and/or in accordance with the optional second time stamp 114 and the content releasing application 105, according to exemplary embodiments. Conceptually, if the second time stamp 114 is employed, then the second time stamp 114 effectively functions as a time-based content release rule, similar to the content release rule 115.

A non-exhaustive list of examples for the network 100 includes wired or optical networks such as the Internet, intranets, Ethernet networks, token rings, Universal Serial Bus (USB), wired networks according to the IEEE 1394-1995, IEEE 1394a-2000, and IEEE 1394b standards (commonly known as “FireWire”), or any combination thereof. The network 100 may include any combination of additional communication devices (not shown) such as gateways, routers, switches, and the like. Alternatively or additionally, the network 100 may be implemented using a wireless network. A non-exhaustive list of examples for a wireless network includes any network capable of implementing communication using Direct Sequence-Code Division Multiple Access (DS-CDMA), Global System for Mobile Communications (GSM), North American Digital Cellular (NADC), Time Division Multiple Access (TDMA), Extended-TDMA (E-TDMA), W-CDMA, GPRS, GSM, Enhanced Data for GSM Evolution (EDGE), 3G and 4G communication, wireless local area networks such as 802.11, Bluetooth™, Zigbee™, ultra wideband (UWB), or various combinations thereof.

The processing mechanism 106 may be implemented using a set-top box (STB), a digital video recorder (DVR), one or more microprocessors, a laptop computer, a personal digital assistant, a computing device, a cellular telephone, a wireless handset, a personal computer, or any of various combinations thereof. The processing mechanism 106 is capable of executing the content releasing application 105. The content releasing application 105 is any software application or instruction set that is capable of enabling access to the subcontent, such as the first and the second subcontent 111, 113, stored on the content storage device 104. Such access is enabled in accordance with one or more content release rules (such as the content release rule 115) after the subcontent 111, 113 has been stored on the content storage device 104 with access not enabled.

The content storage device 104 may be implemented as part of computer program product using any computer readable storage medium, such as a computer disk drive, an optical drive, a magnetic storage drive, read-only memory (ROM), random access memory (RAM), a DVR, a memory-equipped STB, electronic memory storage, or any of various combinations thereof. Although the content storage device 104 and the processing mechanism 106 are shown as separate items, this is for illustrative purposes as it should be clearly understood that the content storage device 104 and the processing mechanism 106 may be implemented using a single hardware device, such as a DVR or memory-equipped STB.

The media display device 108 may be implemented with any device capable of producing a y discernible output in the form of one or more video images, audible sounds, or both. Some illustrative types of the media display devices 108 include, but are not limited to, television sets, laptop computers, wireless telephones, personal digital assistants (PDAs), other Internet Protocol television (IPTV)-capable devices, and personal computers. These devices may be utilized in conjunction with any of a variety of different communication platforms, such as wireless telephony, IP-based communication, and others.

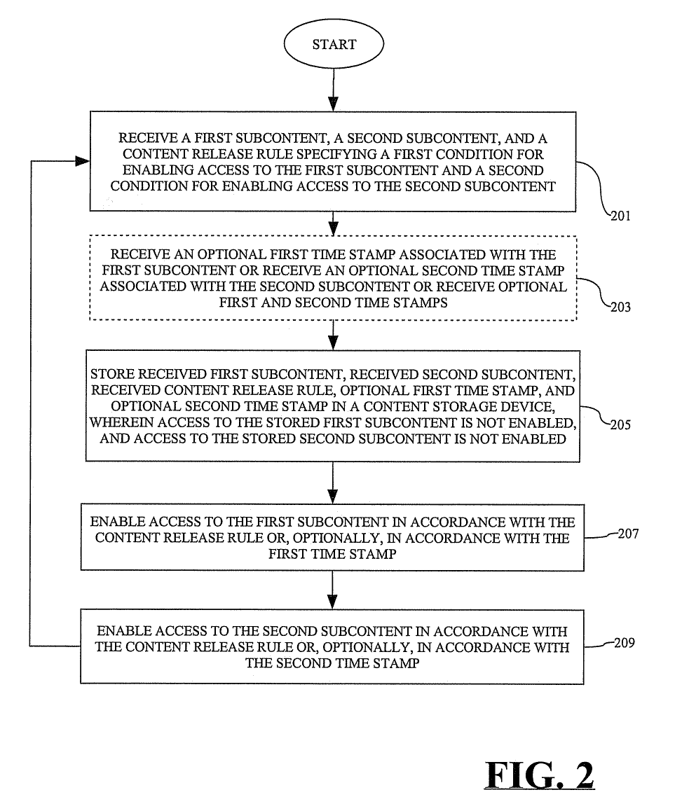

FIG. 2 is a flowchart of an exemplary procedure for rule-based release of distributed electronic content, such as the subcontent 111, 113, in accordance with at least one content release rule, such as the content release rule 115. The procedure commences at block 201 where the first subcontent 111 (FIG. 1), the second subcontent 113, and the content release rule 115 specifying a first condition for enabling access to the first subcontent and a second condition for enabling access to the second subcontent, are received. For example, in the case of an illustrative Internet Protocol television (IPTV) embodiment of the invention, the first subcontent 111, the second subcontent 113, and the content release rule 115 are sent by the content distributor 102 and received by the processing mechanism 106 during off-peak hours when the network 100 is expected to be underutilized. The processing mechanism 106 initiates requests to send content to a user, e.g., a user that has subscribed to that content, or a user that is not the actual subscriber. The processing mechanism 106 accomplishes this function in any of two ways. For EPG-based delivery of content, a scheduler tells the processing mechanism 106 what channels to listen to, when the content may be ingested, and when the content may be stored. For example,the scheduler may inform the processing mechanism 106 to listen to channel 5 from 2 am to 5 am for delivery of content from the Fox Network. For content that is not EPG-related, the user may select “Murder Mysteries” from a menu which tells the processing mechanism 106 to inquire with the content distributor 102 or scheduling system, as to where and when that content would be made available. Once the processing mechanism 106 has that information, the processing mechanism 106 then proceeds to put this information into a recording schedule. The content may or may not be transmitted with more than one sub-content element. In cases where the first subcontent 111 or the second subcontent 113, or both, represent broadcast programs, then the broadcast program may be received by the processing mechanism 106 prior to the scheduled airing date and time for the program.

At the optional block 203 (FIG. 2), the first time stamp 112 (FIG. 1) associated with the first subcontent 111 is received, or the second time stamp 114 associated with the second subcontent 113 is received, or the first and the second time stamps are both received. The first time stamp 112 may be received in addition to the content release rule 115. Similarly, the second time stamp 114 may be received in addition to the content release rule 115. A content distributor 102 may wish to force a user to see content in a particular order, so having the first and second time stamps 112, 114 and the content release rule 115 allows the processing mechanism 106 to perform a test to ascertain whether or not, for example, episode 1 of a program has been seen, before allowing episode 2 to be viewed. Therefore, using the first and second time stamps 112, 114 allows both pieces of content (episodes 1 and 2) to be delivered and released, along with a subsequent rule for viewing the episodes. Alternatively, the first time stamp 112 or the second time stamp 114 or both may be received in lieu of the content release rule 115. In situations where the first time stamp 112 is received in lieu of the content release rule 115, the first time stamp may be conceptualized as a time-based content release rule. Likewise, in situations where the second time stamp 114 is received in lieu of the content release rule 115, the second time stamp may be conceptualized as a time-based content release rule. Illustratively, the first and second time stamps 112, 114 are stored in the content storage device 104. The first and second time stamps 112, 114 are read by the processing mechanism 106 which is operatively coupled to the content storage device 104. For example, the processing mechanism 106 may be implemented using a set top box, and the content storage device 104 may be implemented by a digital video recorder, or an integrated set top box-digital video recorder device may be employed.

Next, at block 205 (FIG. 2), the received first subcontent 111, received the second subcontent 113, and received the content release rule 115 are stored in the content storage device 104 (FIG. 1). Illustratively, the first and second subcontent 111, 113 are stored in the content storage device 104. The content release rule 115 is also stored in the content storage device 104. According to exemplary embodiments, when the first subcontent 111 and the second subcontent 113 are received and stored, access to the first subcontent and the second subcontent is not enabled. For example, when access to the first and the second subcontent 111, 113 is not enabled, a user of the media display device 108 and the processing mechanism 106 is unable to play the first and second subcontent 111, 113 on the media display device 108. If the first time stamp 112 or the second time stamp 114, or both, were received at the optional block 203, then any received time stamp is also stored in the content storage device at block 205.

The procedure of FIG. 2 advances to block 207 where access to the stored first subcontent 111 is enabled in accordance with the content release rule 115 or, optionally, in accordance with the stored first time stamp 112. For example, when the first subcontent 111 is enabled, a user of the media display device 108 and the processing mechanism 106 is able to play the first subcontent on the media display device 108. At block 209 (FIG., 2), access to the stored second subcontent 113 (FIG. 1) is enabled in accordance with the content release rule 115 or, optionally, in accordance with the second time stamp 114. For example, when the second subcontent 113 is enabled, a user of the media display device 108 and the processing mechanism 106 is able to play the second subcontent on the media display device.

When the user looks at stored content in the content storage device 104 through a playback mechanism, such as a media player or equivalent interface (DVR playback) on the media display device 108, the playback mechanism interrogates the time stamps 112, 114 and content release rule 115 (illustratively stored with the content) via the processing mechanism 106 to see if that content can be played or shown to the user in the media display device 108 as available. In a situation in which a user is looking at a scheduled program that was pre-recorded from the content distributor 102, an interrogation from the EPG might say that the program will be ready for viewing in 20 minutes, based on receiving a release time stamp (i.e., the first or second time stamp 112, 114). If content that is delivered on Sunday as part of “Murder Mysteries”, but not viewable until Wednesday for the 3 pieces of sub-content sent, then the 3 pieces of sub-content may not even show up in the folder until Wednesday, even though the content was delivered earlier.

According to an exemplary embodiment, at least one of the first subcontent 111 or the second subcontent 113 includes a marker that specifies when regularly scheduled deletion occurs of EPG based content stored on the content storage device 104 that was previously delivered in advance of the scheduled broadcast time. For example, once two or three weeks of prime time material have been stored, it may make sense to erase items of content that are older than two or three weeks from the storage system, unless the user had specifically marked items of content for recording. This marker is illustratively provided in the form of a third time stamp, or an expiration date identifier, or another data field for determining when items of content are to be erased. For example, the marker may specify an exact date, or an incremental time past the release date. The length of time that content is allowed to remain on the content storage device 104 may, but need not, be determined with reference to the nature of the content. For example, news broadcasts may be retained for one or two days, whereas special movie presentations may be retained for two or three weeks.

Once content is stored on the content storage device 104 for future viewing, the content release rule 115 may be exposed in a user menu on the media display device 108 so that the user can see when an item of content will be available. On the other hand, if the item of content represents a hidden delivery aspect for an element already represented in an EPG, then the user sees nothing new in the EPG. However, if one wishes to create content-based channels (such as, for example, the “Lost™” Channel), and this channel resides outside of a broadcast portion of the EPG (i.e., the channel may be an on-demand channel), then the available episodes of Lost™ may be displayed by media display device 108 under the control of the processing mechanism 106 in the form of a DVR like folder with the time and/or rules of when these episodes will be available for viewing.

As time released content is delivered to the content storage device 104, a recursive listing may be sent back to the content distributor 102 to let the content distributor know that the content was delivered according to a preset delivery package. For example, a checksum of one or more program identifiers may be sent from the processing mechanism 106 to the content distributor 102. If the checksum received at the content distributor from the processing mechanism 106 matches a checksum independently calculated at the content distributor 102, then it is assumed that all content (i.e., all programs) were successfully sent to the content storage device 104. If these checksums do not match, then program identifiers corresponding to each of a plurality of programs may be checked by the processing mechanism 106 to determine which programs or items of content were not received at the content storage device 104.

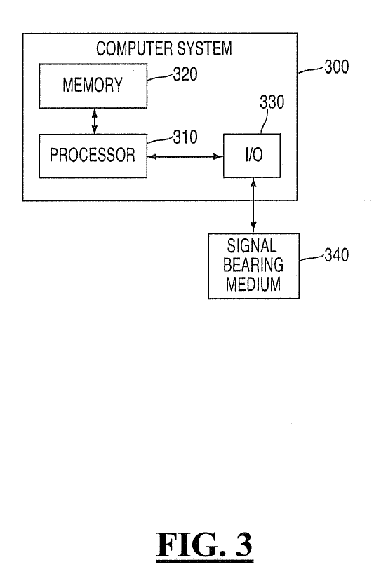

FIG. 3 is a simplified block diagram of an exemplary computer program product for rule-based release of distributed electronic content in accordance with at least one content release rule. The system includes a computer 300 operatively coupled to a signal bearing medium 340 via an input/output interface (I/O) 330. The signal bearing medium 340 may include a representation of instructions for rule-based release of distributed electronic content in accordance with at least one content release rule, and may be implemented as, e.g., information permanently stored on non-writeable storage media (e.g., read-only memory devices within a computer, such as CD-ROM disks readable by a CD-ROM drive), alterable information stored on a writeable storage media (e.g., floppy disks within a diskette drive or hard disk drive), information conveyed to a computer by a communications medium, such as through a computer or telephone network, including wireless or broadband communications networks, such as the Internet, etc.

The computer 300 includes a processor 310 that processes information for rule-based release of distributed electronic content in accordance with at least one content release rule, wherein the information is represented, e.g., on the signal bearing medium 340 and communicated to the computer 300 via the I/O 330, wherein the processor 310 saves information as appropriate into a memory 320. Illustratively, the processor 310 may correspond to the processing mechanism 106 of FIG. 1, and the memory 320 of FIG. 3 may correspond to the content storage device 104 of FIG. 1. Returning now to FIG. 3, this information may also be saved into the memory 320, e.g., via communication with the I/O 330 and the signal bearing medium 340. The processor 310 implements rule-based release of distributed electronic content in accordance with at least one content release rule. The processor 310 receives a first subcontent, a second subcontent, and a content release rule specifying a first condition for enabling access to the first subcontent and a second condition for enabling access to the second subcontent. The received first subcontent, received second subcontent, and received content release rule are stored in the memory 320. Access to the stored first subcontent is not enabled, and access to the stored second subcontent is not enabled. Access to the stored first subcontent is enabled in accordance with the content release rule. Access to the stored second subcontent is enabled in accordance with the content release rule. The foregoing steps may be implemented as a program or sequence of instructions within the memory 320, or on a signal bearing medium, such as the medium 340, and executed by the processor 310.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for rule-based release of distributed electronic content in accordance with at least one content release rule, the method comprising:
receiving a first subcontent, a second subcontent, and a content release rule, the content release rule specifying a first condition for enabling access to the first subcontent and a second condition for enabling access to the second subcontent;
storing the received first subcontent, the received second subcontent, and the received content release rule in a content storage device, wherein access to the stored first subcontent is not enabled and access to the stored second subcontent is not enabled;
enabling access to the stored first subcontent in accordance with the content release rule; and
enabling access to the stored second subcontent in accordance with the content release rule.

2. The method of claim 1 wherein the content release rule includes a first time stamp specifying a time after which access to the first subcontent is enabled.

3. The method of claim 2 wherein the content release rule further includes a second time stamp specifying a time after which access to the second subcontent is enabled.

4. The method of claim 1 wherein access is enabled to the first subcontent by enabling a user to play the first subcontent on a media display device, and wherein access is enabled to the second subcontent by enabling the user to play the second subcontent on the media display device.

5. The method of claim 1 wherein the first subcontent and the second subcontent each represent Internet Protocol television (IPTV) programs.

6. The method of claim 1 wherein the first subcontent, the second subcontent, and the content release rule are sent by a content distributor over a communications network during off-peak hours when the communications network is expected to be underutilized.

7. The method of claim 6 wherein the first subcontent and the second subcontent each represent a broadcast program, and each broadcast program is received by the processing mechanism prior to the scheduled airing date and time for the broadcast program.

8. A computer program product for rule-based release of distributed electronic content in accordance with at least one content release rule, the computer program product including a storage medium readable by a processing circuit and storing instructions for execution by the processing circuit for facilitating a method comprising:
receiving a first subcontent, a second subcontent, and a content release rule, the content release rule specifying a first condition for enabling access to the first subcontent and a second condition for enabling access to the second subcontent;
storing the received first subcontent, the received second subcontent, and the received content release rule in a content storage device, wherein access to the stored first subcontent is not enabled and access to the stored second subcontent is not enabled;
enabling access to the stored first subcontent in accordance with the content release rule; and
enabling access to the stored second subcontent in accordance with the content release rule.

9. The computer program product of claim 8 wherein the content release rule includes a first time stamp specifying a time after which access to the first subcontent is enabled.

10. The computer program product of claim 9 wherein the content release rule further includes a second time stamp specifying a time after which access to the second subcontent is enabled.

11. The computer program product of claim 8 wherein access is enabled to the first subcontent by enabling a user to play the first subcontent on a media display device, and wherein access is enabled to the second subcontent by enabling the user to play the second subcontent on the media display device.

12. The computer program product of claim 8 wherein the first subcontent and the second subcontent each represent Internet Protocol television (IPTV) programs.

13. The computer program product of claim 8 wherein the first subcontent, the second subcontent, and the content release rule are received during off-peak hours when the communications network is expected to be underutilized.

14. The computer program product of claim 13 wherein the first subcontent and the second subcontent each represent a broadcast program, and each broadcast program is received by the processing mechanism prior to the scheduled airing date and time for the broadcast program.

15. An apparatus for rule-based release of distributed electronic content in accordance with at least one content release rule, wherein the apparatus:
receives a first subcontent, a second subcontent, and a content release rule, the content release rule specifying a first condition for enabling access to the first subcontent and a second condition for enabling access to the second subcontent;
stores the received first subcontent, the received second subcontent, and the received content release rule in a content storage device, wherein access to the stored first subcontent is not enabled and access to the stored second subcontent is not enabled;
enables access to the stored first subcontent in accordance with the content release rule; and
enables access to the stored second subcontent in accordance with the content release rule.

16. The apparatus of claim 15 wherein the content release rule includes a first time stamp specifying a time after which access to the first subcontent is enabled.

17. The apparatus of claim 16 wherein the content release rule further includes a second time stamp specifying a time after which access to the second subcontent is enabled.

18. The apparatus of claim 15 wherein access to the first subcontent is enabled by enabling the first subcontent to be displayed, and wherein access to the second subcontent is enabled by enabling the second subcontent to be displayed.

19. The apparatus of claim 15 wherein the first subcontent and the second subcontent each represent Internet Protocol television (IPTV) programs.

20. The apparatus of claim 15 wherein the first subcontent, second subcontent, and the content release rule are sent by a content distributor over a communications network during off-peak hours when the communications network is expected to be underutilized.
